(19) United States
(12) Patent Application Publication
(10) Pub. No.: US 2012/0127378 A1
(43) Pub. Date: May 24, 2012

(54) Television and Electronic Device

(76) Inventors: Mitsuyoshi Takao, Hidaka-shi (JP); Takashi Asano, Fukaya-shi (JP)

(21) Appl. No.: 13/214,992

(22) Filed: Aug. 22, 2011

(30) Foreign Application Priority Data
Nov. 22, 2010 (JP) 2010-260543

(51) Int. Cl. H04N 5/64

(52) U.S. Cl. 348/836; 348/E05.128

(57) ABSTRACT

According to one embodiment, a television includes a display unit with a display screen, a casing with first and second holes, a connection member, projections accommodated in the first and second holes, a support, and a base connected to the support. The casing includes a first face provided with an opening through which the display screen is exposed, a second face opposite to the first face, and a bottom wall. The connection member is made from metal and provided to the bottom wall of the casing. Each projection has a concave portion, with at least a portion of the respective concave portion making contact with a peripheral edge portion of the first hole or the second hole. The projections are detachably fixed to the support. The base includes different design between the display screen side of the base and the opposite side of the base to the display screen.

### CROSS REFERENCE TO RELATED APPLICATION(S)

This application is based upon and claims the benefit of priority from Japanese Patent Application No. 2010-260543 filed on Nov. 22, 2010, the entire contents of which are incorporated herein by reference.

### FIELD

Embodiments described herein relate to a television and electronic device with display apparatus.

### BACKGROUND

Flat screen televisions such as liquid crystal display televisions are, for example, equipped with a display apparatus for displaying videos and a stand. The display apparatus can be removed from the stand and hung on a wall. The television is used with the stand when, for example, placing the television on a TV rack. The stand supports the display apparatus on the placement surface of, for example, a TV rack.

There is demand to increase the scope of variation in design for a television or electronic component with display apparatus at a low cost.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is a perspective view showing a display apparatus as an electronic device according to an exemplary embodiment, as viewed from a display screen side;

FIG. 2 is a perspective view showing the display apparatus as viewed from the opposite side to the display screen;

FIG. 3 is a side view showing the display apparatus (detached state));

FIG. 4 is a side view showing the display apparatus (connected state);

FIG. 5 is a view showing a state in which a display section of the display apparatus has been detached;

FIG. 6 is a view showing the external appearance of a connection section according to the exemplary embodiment, as viewed from the side;

FIG. 7 is a view showing the external appearance of the connection section, as viewed from the rear;

FIG. 8 is a view showing the external appearance of the connection section, as viewed from above;

FIG. 9 is a view showing the external appearance of the connection section, as viewed from the below;

FIG. 10 is a view showing a configuration of the connection section;

FIG. 11 is a perspective view showing the display section and the connection section in a detached state, as viewed from below;

FIG. 12 is a view showing the display section, as viewed from below;

FIG. 13 is a view showing a region for connection to the connection section provided to the display section, as seen from below;

FIG. 14 is a perspective view showing a configuration of a connector according to the exemplary embodiment;

FIG. 15 is a view showing a first variation of a base section according to the exemplary embodiment;

FIG. 16 is a view showing a second variation of a base section according to the exemplary embodiment; and

FIG. 17 is a view showing a third variation of a base section according to the exemplary embodiment.

### DETAILED DESCRIPTION

In general, according to one embodiment, a television includes a display unit, a casing, a connection member, a plurality of projections, a support, and a base. The display unit has display screen. The casing is configured to house the display unit and includes a first face provided with an opening through which the display screen is exposed, a second face positioned on an opposite side of the casing to that of the first face, and a bottom wall. The connection member is made from metal, provided to the bottom wall of the casing and provided with a first hole and a second hole. The plurality of projections are accommodated in the first hole and the second hole in the connection member. Each of the projections is provided with a concave portion on the second face side of the projection, with at least a portion of the respective concave portion making contact with a peripheral edge portion of the first hole or a peripheral edge portion of the second hole. The projections are detachably fixed to the support. The support is configured to support the bottom wall of the casing. The base is connected to the support and includes different design between the display screen side of the base and the opposite side of the base to the display screen.

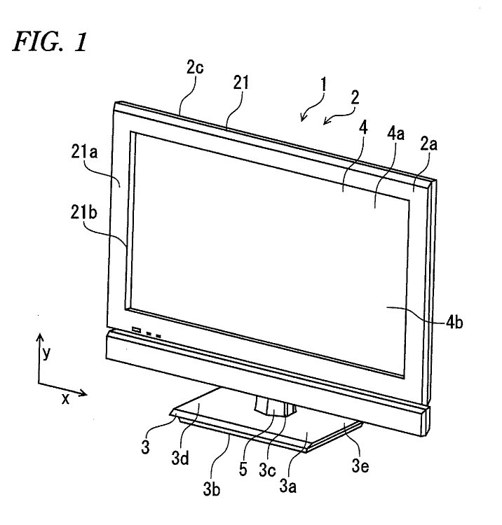

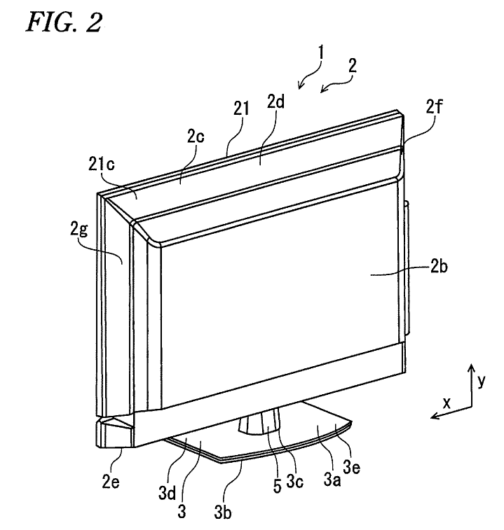

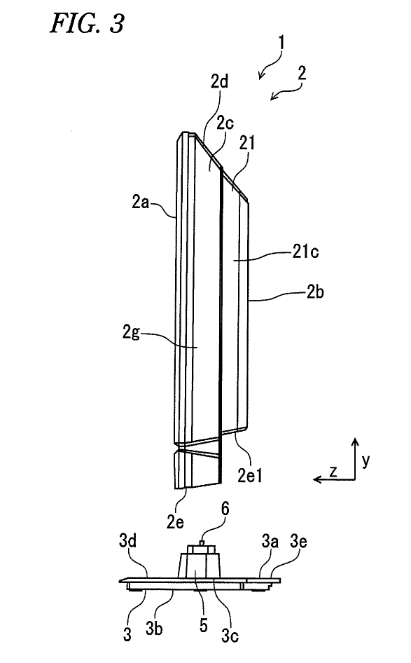

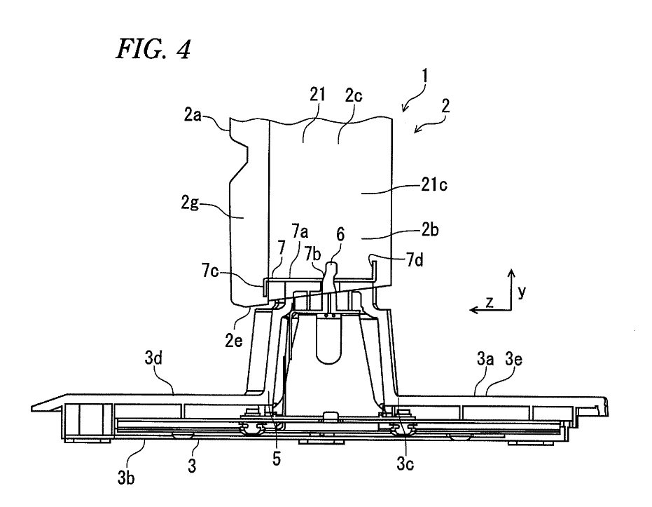

Detailed explanation now follows regarding an exemplary embodiment, with reference to the drawings. For ease of explanation directions are specified as follows. FIG. 1 is a view showing a display section (display, display panel) 2 of a display apparatus (television, broadcast receiving apparatus, electronic device) 1, as viewed from the display screen side. FIG. 2 is a view showing the display section 2 of the display apparatus 1 as viewed from the opposite side to the display screen. FIG. 3 and FIG. 4 are views showing the display screen of the display section 2 of the display apparatus 1 as viewed from the side. Note that FIG. 3 illustrates a state in which the display section 2 has been detached from a base section 3. FIG. 4 shows a state in which the display section 2 has been connected to the base section 3. As an example, the right hand side direction when the display section 2 is viewed face on (in front view) (the left hand side direction when viewed from the rear (in back view)) is designated the direction X, the up direction is designated the direction Y, and the depth direction (front direction) is designated the direction Z. Arrows illustrate these directions in each of the drawings with respect to the assembled state of the display apparatus 1.

As shown in FIG. 1, the display apparatus 1 according to the present exemplary embodiment includes: the base section (base, plate section, support section, support member) 3 that is installed on a desk, for example; the display section 2 housing a display unit 4, such as a Liquid Crystal Display (LCD); and a connection section 5 (coupling section, support section, neck section, support member) connected to the display section 2 and supported by the base section 3.

As shown in FIG. 1, the base section 3 is formed in a rectangular shape in plan view (substantially rectangular shape), adopting a flat shape comparatively thin in the vertical direction. The base section 3 is provided with a top face 3a, a bottom face 3b, a connection portion 3c connected to the connection section 5, a first face portion 3d on the display screen side and incorporating a first design, and a second face portion 3e on the opposite direction to the display screen side and incorporating a second design different from the first design. The first and second designs here indicate the aesthetic appearance of the member, such as the shape of the body, patterning and/or color.

As shown in FIG. 1 and FIG. 2, the display section 2 is configured by a flat substantially rectangular box shape including a front face (display face, first face, front face) 2a, a back face (non-display face, second face, back face) 2b positioned on the opposite side to the front face 2a, a peripheral face (side face) 2c spanning between the front face 2a and the back face 2b. The display section 2 exhibits an rectangular shaped external appearance, thin in the front-rear direction and longer in the width direction when viewed from the front. The peripheral face 2c has face sections split broadly into four sections, a top face (side face, top wall) 2d, bottom face (side face, lower wall, bottom wall) 2e, right face (side face, side wall) 2f, and left face (side face, side wall) 2g.

The display section 2 is provided with a casing 21 that includes a front mask 21a and a back cover 21c. A rectangular shaped opening 21b is provided in the front mask 21a as a portion of the casing 21 covering a peripheral portion of a front face 4a of the display unit 4. The front face 4a of the display unit 4 is exposed through the opening 21b. In the present exemplary embodiment, the portion of the front face 4a of the display unit 4 exposed from the opening 21b configures a display screen 4b. The display screen 4b is disposed upright, as shown in FIG. 1 and FIG. 2.

As shown in FIG. 3, these faces of the casing 21 widen on progression from the back face 2b towards the front face 2a. Namely, the back face 2b has a smaller surface area than the front face 2a, and is positioned so as to fall within the outer periphery of the front face 2a when viewed straight on along the front-rear direction of the display screen. All of the top face 2d, the bottom face 2e, the right face 2f and the left face 2g are of a sloping shape inclined with respect to the front face 2a (the back face 2b).

As shown in FIG. 3, the top face 2d has a steeper slope than the bottom face 2e. Namely, the distance spanning between the front face 2a and the back face 2b is longer on progression along the top face 2d than along the bottom face 2e. The top face 2d is more prominent in external appearance than the bottom face 2e when looking at the electronic device. Forming the top face 2d with a steeper slope achieves the effect of making the external appearance of the electronic device appear thinner. Due to configuration with this shape the electronic components, such as circuit boards, are housed at the back face of the display section 2 positioned at the bottom edge side in the electronic device of the present exemplary embodiment.

As shown in FIG. 3, the bottom face 2e has a second bottom face (second face, second bottom wall, step face) 2e1. The second bottom face 2e1 is provided further to the top face 2d side than the bottom face 2e. Configuration with such a shape achieves a similar effect to sloping the top face 2d, namely makes the external appearance of the electronic device appear thinner.

In addition to the display unit 4, the board mounted with electronic components, such as a Central Processing Unit (CPU) and other electronic components (not shown in the drawings), are also housed in the casing 21 of the display section 2. The display unit 4 receives a video signal from a video signal processing circuit included in a control circuit configured with electronic components mounted on a board (not shown in the drawings), and displays an image, such as a still picture or motion picture, on the display screen 4b. When the display apparatus 1 is configured by a television set, the control circuit of the display apparatus 1 includes, in addition to the video signal processing circuit, for example, a tuner section and a High Definition Multimedia Interface (HDMI) signal processing section, an Audio Video (AV) input terminal, a remote controller signal receiver, a controller, a selector, an on-screen display interface, a storage section (for example, Read Only Memory (ROM), Random Access Memory (RAM) or a Hard Disk Drive (HDD)) and an audio signal processing circuit. The board is housed in the casing 21 towards the rear (at the back face side) of the display unit 4. When the display apparatus 1 is configured by a computer, the control circuit of the display apparatus 1 includes, for example, a controller (for example a CPU) and a storage section (for example, Read Only Memory (ROM), Random Access Memory (RAM) or a Hard Disk Drive (HDD)), a display driver, and a communication interface. The display apparatus 1 also includes an amp and speakers for audio output (not shown in the drawings).

As shown in FIG. 3 and FIG. 4, projections 6 are provided to the connection section 5, projecting out towards the display section 2 side. The projections 6 are inserted into the casing 21 and connect together the display section 2 and the connection section 5. As shown in FIG. 4, a connector (connection section, reinforcement section, metal section, metal plate) 7 for connecting to the projections 6 are provided at the bottom face 2e of the display section 2. The connector 7 is provided by a member of higher rigidity than the casing 21, for example from metal, and is less susceptible to deformation or damage when supporting the load of the display section 2 than the casing 21.

As shown in FIG. 4, the connector 7 has a region (plate portion, support face, engaging face, engaged face) 7a that is formed in a plate shape extending parallel (substantially parallel) to the base section 3. The region 7a both extends parallel (substantially parallel) to the top face of the connection section 5 and makes contact with the top face. Openings (through holes, hole portions, holes, engaging portions, engaged portions, through connection portions) 7b are provided in the region 7a, and the projections 6 pass through the respective openings 7b. The projections 6 make contact with at least a portion of the peripheral edge of their respective openings 7b.

The connector 7 also has a first bent portion (front bend, downward bend, folded portion) 7c provided bending downwards at the display face side of the connector 7, and a second bent portion (rear bend, upward bend, folded portion) 7d provided bending upwards at the opposite side of the connector 7 to the display face. By provision of these front and rear bent portions, the display section 2 can be suppressed from tipping over forwards when, for example, the casing 21 warps due to external stress, such as from oscillation. By adopting such a configuration, the connector 7 can also be made to conform to the sloping shape of the bottom face 2e of the casing 21, and equal pressure can be applied at the front and rear when contacting the bottom face 2e. Stress can accordingly be suppressed from concentrating at a rear portion of the bottom face 2e of the casing 21, which might result in damage or deformation.

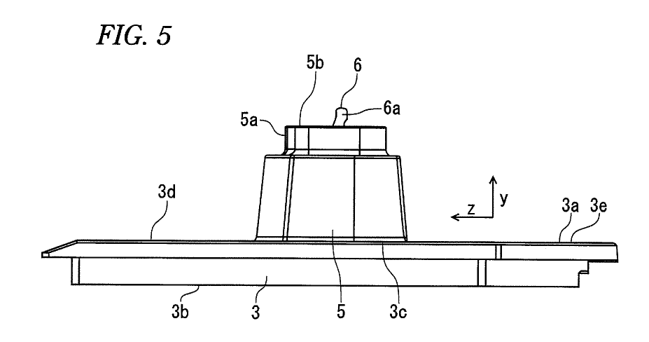

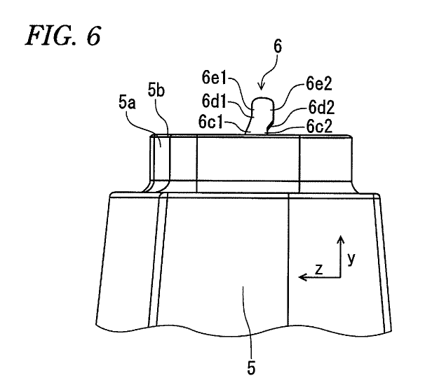

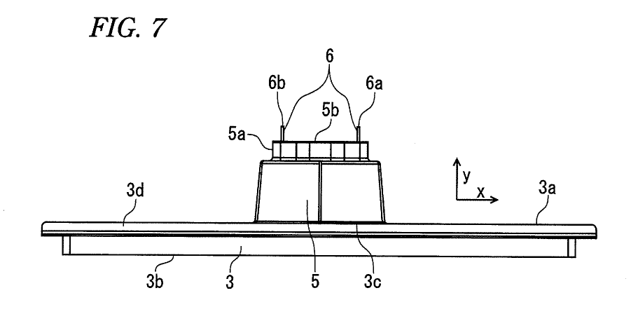

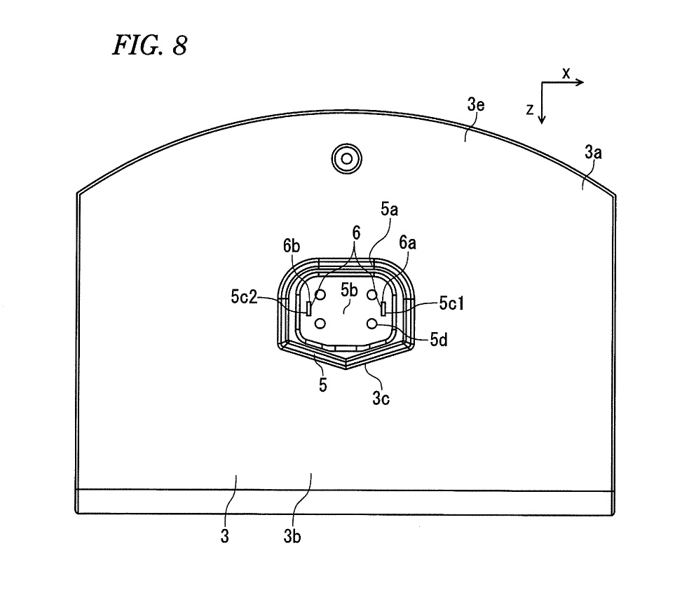

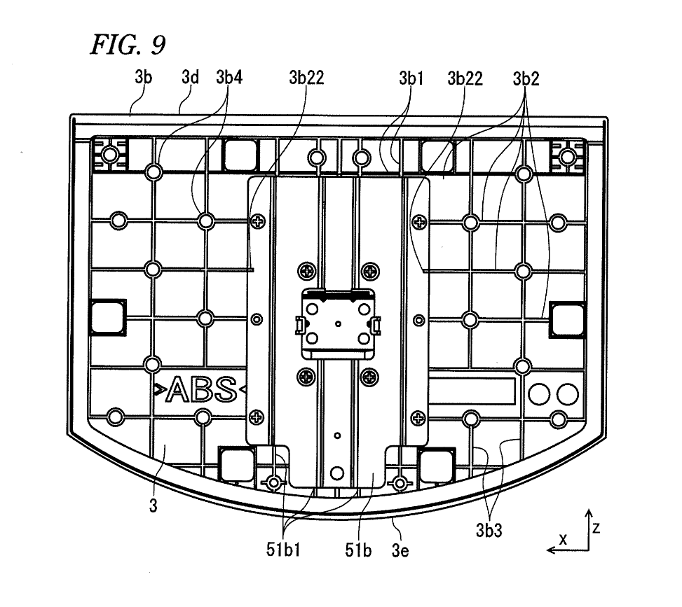

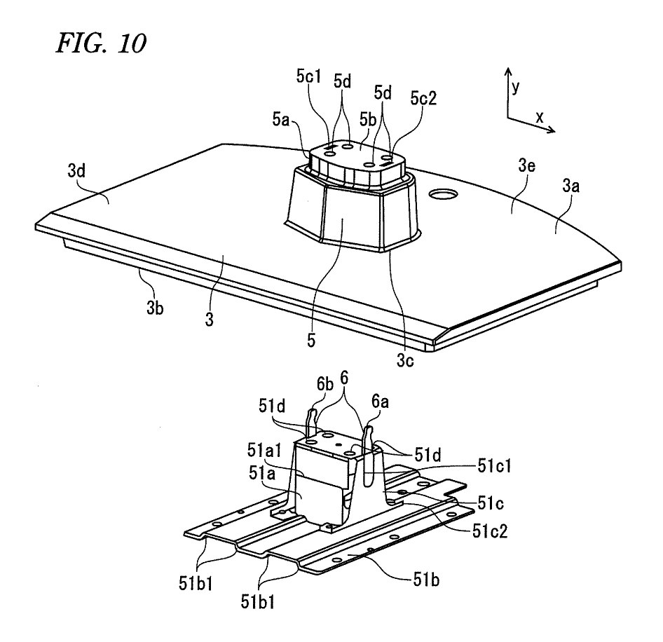

Explanation now follows regarding a configuration in the vicinity of the connection section in the present exemplary embodiment, with reference to FIG. 5 to FIG. 9. FIG. 5 is a view showing a state in which the display section 2 of the display apparatus 1 has been detached, namely a view showing the base section 3 and the connection section 5. FIG. 6 to FIG. 8 are views of the external appearance of the connection section 5 of the present exemplary embodiment. FIG. 6 is a view showing the connection section 5 as viewed from the side, FIG. 7 is a view showing the connection section 5 as viewed from the rear, and FIG. 8 is a view showing the connection section 5 as viewed from above. FIG. 9 is a view of the connection section 5 (the base section 3) as viewed from the below. FIG. 10 is a view showing a configuration of the connection section 5 in the present exemplary embodiment.

As shown in FIG. 5 to FIG. 10, the connection section 5 includes a step portion 5a positioned at the top end of the connection section 5, and a flat face portion 5b configuring the face on the display section 2 side of the step portion 5a. The projections 6 are provided so as to project out from the flat face portion 5b. The projections 6 are positioned at a central portion of the connection section 5 (the flat face portion 5b) as viewed from the side.

As shown in FIG. 7 to FIG. 10, the projections 6 include a first projection (first portion, hook portion, positioning portion, projection portion, protruding portion, fitting portion) 6a, and a second projection (second portion, hook portion, positioning portion, projection portion, protruding portion, fitting portion) 6b. The first and second projections 6a, 6b are both formed in the same shape. In order to simplify explanation, the configuration of the projections 6 will be explained here using the first projection 6a as an example.

As shown in FIG. 5 and FIG. 6, the projection 6 includes, on its display section 2 display screen side face: a first sloping portion 6c1 sloping towards the back face 2b side of the casing 21; a first concave portion 6d1 open towards the display section 2 display screen side; and a first extending portion (head portion, protruding portion) 6e1 extending towards the display section 2 side. The projection 6 also includes, on the face on the opposite side to the display section 2 display screen: a second sloping portion 6c2 sloping towards the opposite side to the display section 2 display screen side, namely towards the back face 2b side of the casing 21; a second concave portion 6d2 open towards the opposite side to the display section 2 display screen; and a second extending portion (head portion, protruding portion) 6e2 extending towards the display section 2 side.

The first and second concave portion portions 6d1, 6d2 are positioned between the first and second sloping portions 6c1, 6c2 and the first and second extending portions 6e1, 6e2, respectively.

As shown in FIG. 4, the first and second concave portion portions 6d1, 6d2 engage with at least a portion of the peripheral edge of the opening 7b formed in the connector 7. The display section 2 has a center of gravity disposed towards the side where the display panel is positioned. In other words the display apparatus 1 is configured with more of a tendency to fall forwards than backwards. Configuration of the present exemplary embodiment is configured with the first concave portion 6d1 and the extending portion 6e1 to make contact with and be supported at the front peripheral edge of the opening 7b. Configuration is also made with the second concave portion 6d2 and the second sloping portion 6c2 to make contact with and be supported at the rear peripheral edge of the opening 7b. The display apparatus 1 with center of gravity disposed towards the front can be efficiently supported by such a configuration.

In the configuration of the present exemplary embodiment, providing the first and second sloping portions 6c1, 6c2 at the front and rear, respectively, enables distribution of load application between each of the projections 6 and the peripheral edge of each of the openings 7b. Consider, for example, configuration without provision of the first and second sloping portions 6c1, 6c2, with a hook shape formed with a portion extending out towards the display section 2 and a portion orthogonal thereto. In such a configuration, since the contact region of each of the projections 6 with the peripheral edge of the opening 7b is decreased, stress tends to concentrate at a particular point, in particular at the leading end of the hook (the leading end of the portion orthogonal to the portion extending out towards the display section 2 side). As a result, the possibility arises of the projections 6 or the peripheral edge portion of the openings 7b deforming or breaking. Consequently, the configuration of the present exemplary embodiment provided with the first and second sloping portions 6c1, 6c2 can reduce the possibility of deformation or breaking of the projection 6 or the peripheral edge portion of the opening 7b.

In the configuration of the present exemplary embodiment, by provision of the first and second extending portions 6e1, 6e2 at the front and rear, respectively, the display section 2 and the connection section 5 can be prevented from coming apart even if the display apparatus 1 is about to tip over backwards. For example, as situation can be envisaged in which the display apparatus 1 becomes tilted towards the rear when the display apparatus 1 is shaken strongly in the front-rear direction, such as by an earthquake. However, due to the configuration of the present exemplary embodiment, since the first and second extending portions 6e1, 6e2 are supported by the opening 7b from the front and rear, respectively, the projections 6 can be prevented from pulling out from the openings 7b, and the display section 2 and the connection section 5 can be prevented from coming apart.

As shown in FIG. 10, the base section 3 and the connection section 5 of the present exemplary embodiment are formed from a resin so as to be integrally connected together. An opening is formed in the bottom face 3b of the base section 3 so as to communicate with the inside of the connection section 5, and a portion of a metal support portion 51 is inserted inside the opening. The support portion 51 has the projections 6 formed at its leading end, and includes a first support portion 51a housed in the connection section 5, and a second support portion 51b connected to the first support portion 51a and making contact with the bottom face 3b of the base section 3. The first and second projections 6a, 6b are inserted into two respective through holes (openings, hole portions, holes) 5c1, 5c2 that are provided in the flat face portion 5b of the connection section 5 so as to externally expose the inside of the connection section 5. Fixing holes (openings, hole portions, holes) 5d are formed in the flat face portion 5b for letting fixing members, such as screws, pass through. The fixing holes 5d are positionally arranged so as to communicate with fixing holes (openings, hole portions, holes) 51d provided in the support portion 51.

As shown in FIG. 10, the through holes 5c1, 5c2 are provided with extra length compared to the front-rear direction width of the two projection portions 6a, 6b (about 1.5 times the length). Namely, in the state in which the two projection portions 6a, 6b are inserted into the through holes 5c1, 5c2, there is play enabling some movement of the two projection portions 6a, 6b in the front-rear direction. Such a configuration avoids contact of the two projection portions 6a, 6b with the through holes 5c1, 5c2 when the two projection portions 6a, 6b bend in the front-rear direction, and a path by which stress might have been transferred is interrupted.

As shown in FIG. 10, the front of the connection section 5 has a protruding shape that is pointed towards the center when viewed from above. Such a shape not only raises the design appeal of the connection section 5, but also contributes to suppressing forward tipping over of the display apparatus 1.

As shown in FIG. 10, the first support portion 51a of the present exemplary embodiment is configured from plural metal plates. There is a region (superimposed portion, overlapping portion) 51a1 where portions of the metal plates overlap with one another. This region 51a1, in particular since overlap is provided in the front-rear direction) raises the rigidity (in particular the rigidity to load applied in the front-rear directions) in comparison to metal forming with a single plate.

As shown in FIG. 10, the second support portion 51b of the present exemplary embodiment has bent sections 51b1 bent along a direction intersecting with the left-right extending direction, namely extending along the front-rear direction. The rigidity of the second support portion 51b, and consequently the rigidity of the base section 3, can be raised by the configuration with the bent sections 51b1 of the present exemplary embodiment. The second support portion 51b is formed with a shape extending along the front-rear direction of the casing 21, thereby suppressing bending of the base section 3 in the front-rear direction. When, for example, the display apparatus 1 is shaken strongly in the front-rear direction, such as by an earthquake, deformation or breakage in the vicinity of the connection portion 3c where the base section 3 and the connection section 5 are connected together can be suppressed.

As shown in FIG. 10, the first and second projections 6a, 6b in the present exemplary embodiment are provided by cutting out a portion of each side face 51c of the first support portion 51a and projecting the cut out portions upwards. Cut out portions (openings, hole portions, holes) 51c1 are formed in the top end of the side faces 51c of the first support portion 51a at the periphery of the locations where the two projection portions 6a, 6b were cut out. A portion (fixing portion, holding portion, support portion, base portion) 51c2 fixed to the second support portion 51b is provided at the bottom end of the side faces 51c of the first support portion 51a. The portion 51c2 is longer than the width of flat portions 5c, and so as to spread out at the bottom from the side faces 51c that form a mountain shape when viewed from the side. Adopting such a configuration in the first support portion 51a of the present exemplary embodiment contributes to suppressing flexing of the display apparatus 1 in the front-rear direction. Due to provision of the cut out portions 51c1 in regions at the vicinity of the two projection portions 6a, 6b which are particularly susceptible to application of load from the display section 2, not only can flexing of the display section 2 be absorbed, but strong fixing support can also be achieved from the portion 51c2 below.

As shown in FIG. 10, the base portion 51c2 in the present exemplary embodiment is provided in a region separated from the mounting surface, such as a desk top, by the bent sections 51b1. Due to such a configuration, even if there is deformation of the second support portions 51b due to being affected by loading from the display section 2, such as load transmitted through the base portions 51c2, the possibility of the deformed portion making contact with the mounting surface, such as a desk top, can be reduced.

As shown in FIG. 9, there are lattice shaped ribs 3b1 provided to the bottom face 3b of the base section 3 in the present exemplary embodiment. The ribs 3b1 are upright walls extending in the casing 21 top-bottom direction, and include ribs 3b2 extending along the left-right direction, and ribs 3b3 extending along the front-rear direction. There are also circular column shaped ribs 3b4 provided at portions where portions extending in the left-right direction and front-rear direction overlap with each other. By adopting such a shape, the rigidity to flexing of the base section 3 in the present exemplary embodiment can be suppressed from being significantly reduced even though a form is adopted for reduced weight by molding in a resin material with thinned portions. The rib shape is not limited to a lattice shape, and configuration may be made with any shape that gives a flexing suppression effect, such as a honeycomb shape for example, without limitation to the particular configuration of the present exemplary embodiment.

As shown in FIG. 9, in the configuration of the present exemplary embodiment, portions 3b22 of the ribs 3b2 extending in the left-right direction are housed in cut out portions of the second support portion 51b, a metallic member that supports the base section 3 from the back. The portions 3b22 of the ribs 3b2 are provided further forwards than the connection section 5 and contribute to suppressing the display apparatus 1 from tipping forwards.

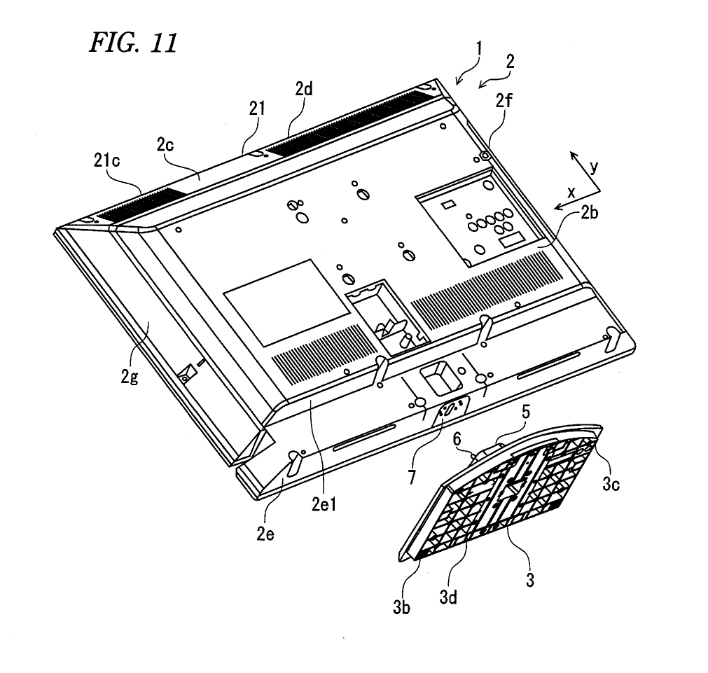

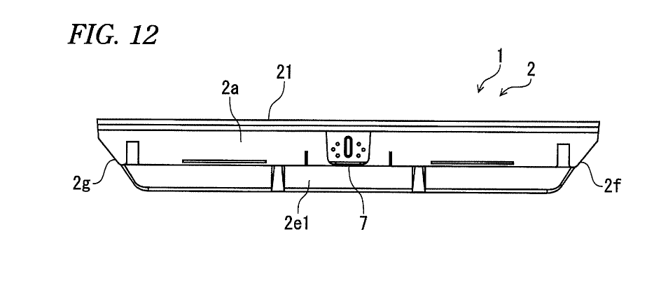

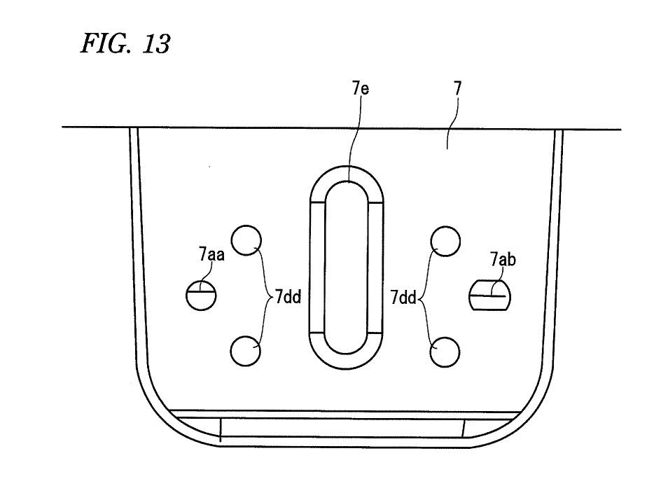

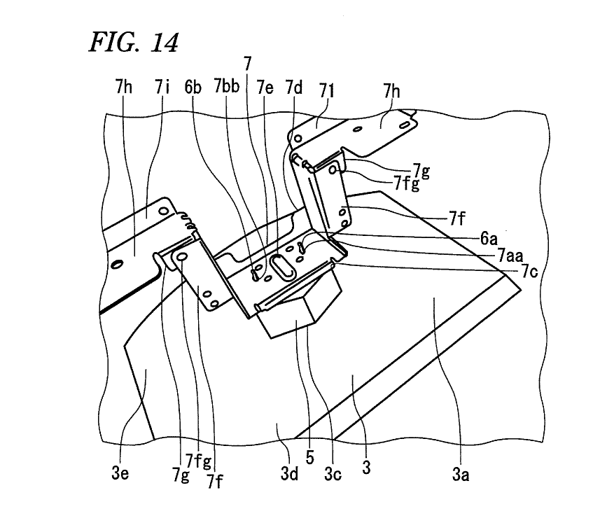

Explanation now follows regarding configuration of the present exemplary embodiment at the vicinity of the contact portion on the display section 2 side, with reference to FIG. 11 to FIG. 14. FIG. 11 is a perspective view of the display section 2 and the connection section 5 in a detached state, as viewed from below. FIG. 12 is a view of the display section 2 of the present exemplary embodiment as viewed from below. FIG. 13 is a view of a region for connection to the connection section 5 provided to the display section 2 of the present exemplary embodiment, as seen from below. FIG. 14 is a perspective view showing the connector connected to the connection section 5 of the present exemplary embodiment.

As shown in FIG. 11 to FIG. 14, the connector (central portion, connection portion, engaging portion, fixing portion) 7 in the present exemplary embodiment is provided at the center of the bottom face 2e of the display section 2 for connecting to the connection section 5. Insertion openings (openings, connection portions, hole portions, holes) 7aa, 7bb are formed in the second bottom face 2e1 for insertion of the first and second projections 6a, 6b, respectively. The shape of the insertion openings 7aa, 7bb are different from each other. In assembly of the display apparatus 1 in the configuration of the present exemplary embodiment, the display section 2 is assembled separately from assembly of the connection section 5 and the base section 3, and then finally the connection section 5 is connected from the bottom face 2e of the display section 2. Forming the insertion openings 7aa, 7bb with different shapes from each other as viewed from the bottom face 2e of the display section 2 enables the front and rear directions of the base section 3 to be visibly distinguished by an assembly operator, and productivity of the assembly operation can be raised.

As shown in FIG. 13, a protrusion (indented portion, protrusion portion, deformation portion, strengthening portion, bending portion) 7e is provided to the connector 7 between the insertion openings 7aa, 7bb, so as to project out towards the display section 2 side. The protrusion 7e is provided by press forming a portion of the connector 7. The protrusion 7e is formed in an oval shape extending along the front-rear direction. The resilience of the display apparatus 1 of the present exemplary embodiment to flexing in the front-rear direction is raised by adopting such a configuration. Fixing holes (openings, hole portions, holes) 7dd are formed between the protrusion 7e and the insertion openings 7aa, 7bb. The fixing holes 7dd have a positional relationship so as to communicate with the fixing holes 51d formed in the support portion 51.

As shown in FIG. 14, the connector 7 is formed into a shape that enables it to be fixed and engaged with the inner wall in the casing 21. The connector 7 is configured from a single plate of metal, with plural tabs (fins, support portions, plate portions, wall portions) 7f, 7g, 7h, 7i formed by cutting and bending at plural locations. The tabs (fins, support portions, plate portions, wall portions) 7f, 7g, 7h, 7i exhibit a similar effect to the first bent portion (front bend, downward bend, folded portion) 7c provided bending downwards at the display screen side, and the second bent portion (rear bend, upward bend, folded portion) 7d provided bending upwards at the opposite side to the display screen, as described above in the explanation with respect to FIG. 4. Namely, these tabs can suppress the display section 2 from tipping forwards when, for example, the casing 21 flexes due to external stress being applied, such as from oscillation. By adopting such a configuration, the connector 7 can also be made to conform to the sloping shape of the bottom face 2e of the casing 21, and equal pressure can be applied at the front and rear when contacting the bottom face 2e. Stress can accordingly be prevented from concentrating at a rear portion of the bottom face 2e of the casing 21, which would result in damage or deformation. There are several tabs 7f, 7g, 7h, 7i form the tabs 7f, 7g, 7h, 7i that have overlapping portions 7gh where they overlap with each other. The overlapping portions 7gh are configured so as to support each other by common fastening, for example, through common screw holes.

As shown in FIG. 12 to FIG. 14, in the configuration of the present exemplary embodiment, one or other of the insertion openings 7aa, 7bb is formed as an elongated hole. By adopting such a configuration, a small amount of play for rotation about the other insertion opening can be provided. Accordingly, more tolerance can be provided for the precision of the assembly operation, and operationally efficiency of the display apparatus 1 assembly operation can be raised.

In the configuration of the present exemplary embodiment, since the projections 6 serve both the function of positioning and the function of engaging and connecting, there is no need to separately provide a positioning member and an engaging and connecting member, achieving a reduction in the number of components.

As described in the present exemplary embodiment above, the base section 3 includes, on the display screen side, the first face portion 3d incorporating a first design, and, on the opposite side to the display screen side, the second face portion 3e incorporating a second design different from the first design. Due to the construction of the present exemplary embodiment, the projections 6 projecting out from the connection section 5 are inserted into and fixed to the display section 2. Whilst the present exemplary embodiment of FIG. 1 to FIG. 14 is a structure mainly aimed at preventing tipping over forwards, employing this structure on both sides in the front-rear direction enables the base section 3 to be attached to the display section 2 with the front and rear directions reversed.

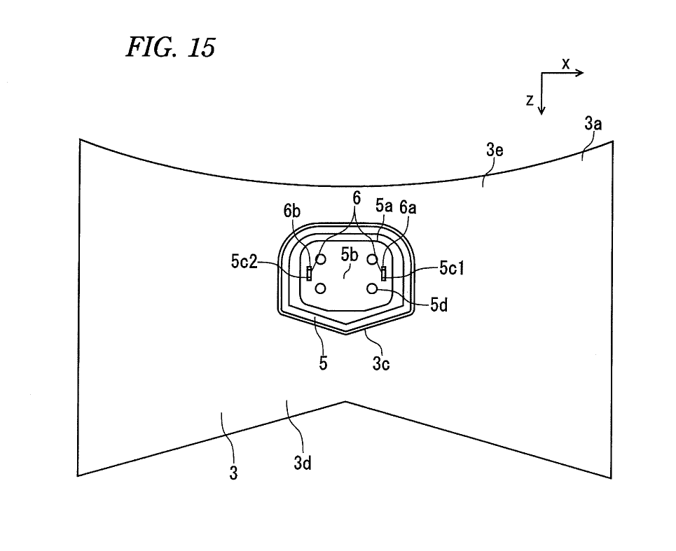

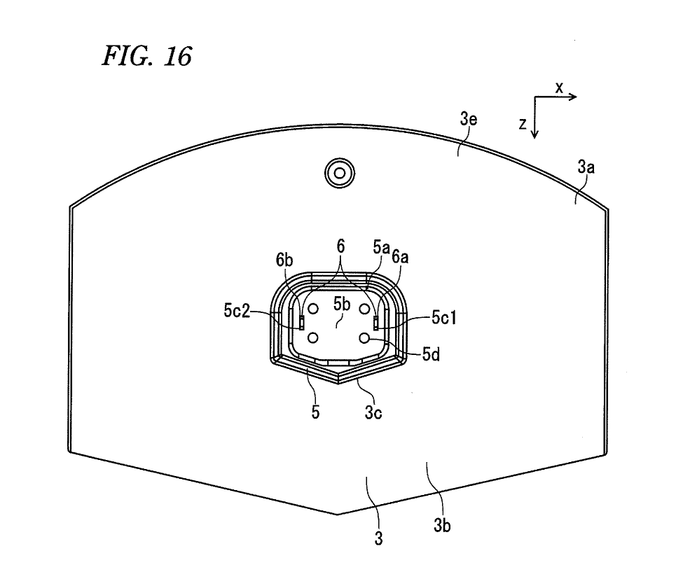

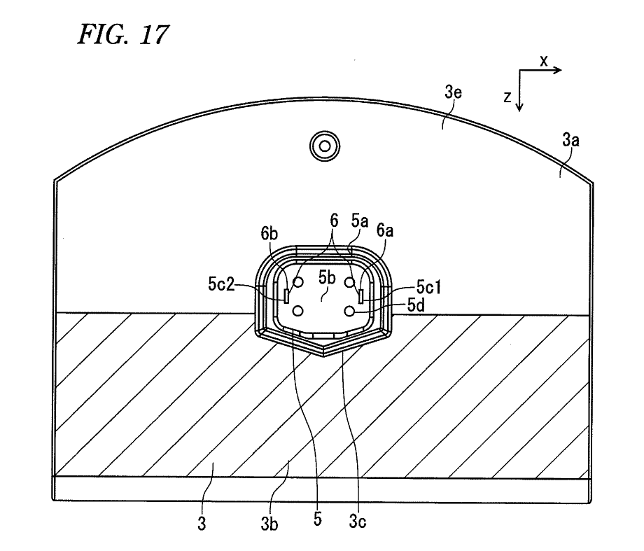

FIG. 15 to FIG. 17 show some design variations for the base section 3. As shown in FIG. 15 to FIG. 17, the construction of the present exemplary embodiment enables a wide range of design variations to be adopted for the display apparatus 1, by changing the shape, patterning and coloring of the front and rear of the base section 3, enabling low cost provision of a multitude of external appearances to match the tastes of users.

While explanation is given above of preferable exemplary embodiments and various modifications are possible without limitation to the above exemplary embodiments. For example, while the projections 6 are provided to the connection section 5 in the above exemplary embodiment, configuration may be made with the projections 6 provided on the display section 2 side. Configuration may also be made with the connection section 5 and the base section 3 formed from separate members connected together rotatably. Configuration may be made with only a single projection 6, or with three or more projections 6, as long as a configuration is achieved in which the display section 2 and the connection section 5 can be attached to each other.

Embodiments described herein can be implemented with any electronic device having a display screen, and application can be made, for example, to a display apparatus other than a television set, an electronic device display apparatus, a display apparatus configured as a personal computer.

Appropriate modifications can also be implanted to the electronic device, and also to the specification of, for example, the display apparatus, base section, base, opening, through hole, display section, projection portion, projection, concave portion, connection portion, support portion, supported portion, plate, groove, rib (such as changes to their structure, shape, material, size, length, width, thickness, height, number, layout, and position).

According to the present exemplary embodiment, a display apparatus (television) and electronic device can be obtained capable of raising assembly productivity.

According to the present exemplary embodiment, a display apparatus (television) and electronic device can be obtained capable of widening the range of design variations of the display apparatus 1.

While certain embodiments have been described, these embodiments have been presented by way of example only, and are not intended to limit the scope of the invention. Indeed, the novel apparatus described herein may be embodied in a variety of other forms; furthermore, various omissions, substitutions and changes in the form of the apparatus, described herein may be made without departing from the spirit of the invention. The accompanying claims and their equivalents are intended to cover such forms or modifications as would fall within the scope and spirit of the invention.

What is claimed is:

1. A television comprising:
a display unit with display screen;
a casing configured to house the display unit and comprising a first face provided with an opening through which the display screen is exposed, a second face positioned on an opposite side of the casing to that of the first face, and a bottom wall;
a connection member made from metal, provided to the bottom wall of the casing and provided with a first hole and a second hole;
a plurality of projections accommodated in the first hole and the second hole in the connection member, each of the projections being provided with a concave portion on the second face side of the projection, with at least a portion of the respective concave portion making contact with a peripheral edge portion of the first hole or a peripheral edge portion of the second hole;
a support to which the projections are detachably fixed, the support being configured to support the bottom wall of the casing; and
a base connected to the support and comprising different design between the display screen side of the base and an opposite side of the base to the display screen.

2. The television of claim 1, wherein the first hole and the second hole are each formed with different shapes from each other, and either the first hole or the second hole has a greater opening surface area than the other.

3. The television of claim 2, further comprising:
a reinforcement member made from metal and housed within the support,
wherein the plurality of projections are monolithically provided to the reinforcement member.

4. The television of claim 3, wherein the base is connected to the support at an opposite side to the display unit, and the reinforcement member comprises a portion that opposes a bottom face of the base.

5. The television of claim 4, wherein the portion of the reinforcement member that opposes the bottom face of the base comprises a bent portion extending along a thickness direction of the casing.

6. The television of claim 5, wherein lattice shaped ribs are formed to the bottom face of the base.

7. An electronic device comprising:
a support;
a display section comprising a bottom wall, the bottom wall being provided with an opening and having a sloping portion;
an insertion portion inserted into the opening in the bottom wall and configured to connect the support and the display section together;
a concave portion provided to the insertion portion so as to engage with a portion of the bottom wall; and
a design section to which the insertion portion is detachably fixed, the design section having a different design between the display screen side of the design section and an opposite side of the design section to the display screen.

8. The device of claim 7, further comprising:
a reinforcement member made from metal and housed within the design section, the insertion portion being monolithically provided to the reinforcement member,
wherein the design section is configured to support the display section.
